(19) United States
(12) Patent Application Publication
(10) Pub. No.: US 2021/0119285 A1
(43) Pub. Date: Apr. 22, 2021

(54) BATTERY CELL

(71) Applicant: HONDA MOTOR CO., LTD., Tokyo (JP)

(72) Inventors: Takuya TANIUCHI, Saitama (JP); Masahiro OHTA, Saitama (JP)

(21) Appl. No.: 17/042,201

(22) PCT Filed: Mar. 22, 2019
(86) PCT No.: PCT/JP2019/012196

§ 371 Date: Sep. 28, 2020

(30) Foreign Application Priority Data
Mar. 30, 2018 (JP) 2018-067610

(51) Int. Cl. H01M 50/105; H01M 50/533; H01M 50/107

(52) U.S. Cl. CPC H01M 50/105; H01M 50/107; H01M 50/533

(57) ABSTRACT

Provided is a solid-state battery cell that can effectively improve the volume energy density of a battery module, while maintaining the sealing performance of an exterior body. A battery cell 1 comprises a battery 10 and an exterior body 2 that houses the battery. The battery 1 has a positive electrode, an electrolyte, and a negative electrode. The exterior body 2 has a turnback section 21, which is formed of a single film folded back in order to house the battery 1, and bonded sections 22a, 23a, 24a, which are formed by bonding opposite edges of the film.

### TECHNICAL FIELD

The present invention relates to a battery cell.

### BACKGROUND ART

As electric and electronic products that vary in size, such as vehicles, personal computers, and mobile phones, have been spreading widely in recent years, the demands of high voltage or high capacity batteries have been quickly expanding. As such a battery, the liquid battery cell using an organic electrolytic solution as the electrolyte between the positive electrode and negative electrode, a solid state battery cell made using a solid electrolyte which is a flame-retardant solid in place of the electrolyte of organic electrolytic solution, etc. can be exemplified.

The solid state battery including the solid electrolyte, compared to a battery including the organic electrolytic solution as the electrolyte, excels in the point of the safety improving due to the electrolyte being non-flammable, and the point of having much higher energy density, and thus is currently attracting attention (for example, Patent Document 1).

On the other hand, as such as battery, one has been known of laminate-cell type sealed in a plate shape by wrapping a rectangular parallelepiped cell with a laminate film, and in the application of EV, HEV or the like, a battery pack made by accommodating a plurality of such batteries of laminate cell-type by placing side by side within a case are being used (hereinafter may be denoted as battery module or solid state battery module). By wrapping with the external body, it is possible to prevent the intrusion of atmospheric air to the battery.

For example, a solid state battery including a laminate cell which can easily identify the leakage of gas from the external body such as a battery pack case is disclosed (for example, Patent Document 2). Patent Document 2 discloses being able to easily identify a site at which such leaking occurred even in a case of leading of gas from the external body occurring.

Patent Document 1: Japanese Unexamined Patent Application, Publication No. 2017-147158

Patent Document 2: Japanese Unexamined Patent Application, Publication No. 2012-169204

### DISCLOSURE OF THE INVENTION

### Problems to be Solved by the Invention

However, upon sealing the battery by wrapping with film, it is common to wrap the battery with two films, and seal by bonding the four side of the films opposing each other.

However, it is necessary for a bonded section in which films are bonded to bond at least a predetermined area from the viewpoint of the sealing performance of the external body, and this bonded section itself becomes a so-called dead space occupying a space within a case, in the case of accommodating a plurality of battery cells by placing side by side within the case. This dead space causes a decline in the energy density of the battery module.

Furthermore, this bonded section is demanded to increase the area thereof as much as possible from the viewpoint of sealing performance of the external body. In the case of sealing by bonding each side of the laminate, it is necessary to increase the bonding area of the bonded section form the viewpoint of ensuring the sealing performance as the cell thickness is made thicker in particular, and thus the above-mentioned dead space further increases.

The present invention has an object of providing a battery cell which can effectively improve the energy density of the battery module, while maintaining the sealing performance of the above-mentioned external body.

### Means for Solving the Problems

The present inventors have found, as a result of diligently investigating in order to solve the above-mentioned problem, found that it is possible to solve the above-mentioned problem if being a battery cell including an external body in which a single film is folded back so as to accommodate the battery, thereby arriving at completing the present invention.

The present invention provides a battery cell including a battery and an external body which accommodates the battery, in which the battery includes a positive electrode, an electrolyte and a negative electrode, and in which the external body includes a turnback section which is formed by one film being folded back so as to accommodate the battery, and a bonded section in which ends of the film opposing each other are bonded.

It is thereby possible to effectively improve the energy density of a battery module, while maintaining the sealing performance of the external body.

The battery may be a solid state battery, and The solid state battery may include a battery laminate in which at least a positive electrode layer, electrolyte layer and negative electrode layer are laminated in this order.

It may further include a support which accommodates the battery laminate, and a film extension part of the external body formed on both sides of the turnback section by the bonded section being formed may be folded to a side of the support.

The external body may accommodate the battery laminate within one film of cylindrical shape.

The battery may further include a current collector tab connected to the battery laminate, and an end of the current collector tab on an opposite side to a side of the battery laminate may be exposed from the external body.

The bonded section may be formed by welding.

### Effects of the Invention

According to the present invention, it is possible to effectively improve the energy density of a battery module, while maintaining the sealing performance of an external body.

### BRIEF DESCRIPTION OF THE DRAWINGS

FIG. 1 is a perspective view showing an outline of a solid state battery cell 1 according to the present embodiment;

FIG. 2 is a cross-sectional view cut along the line X-X of the solid state battery cell 1 (solid state battery 10) according to the present embodiment in FIG. 1;

FIG. 3 is a perspective view showing an outline of an external body 100 provided to the solid state battery cell according to the present embodiment;

FIG. 4 is a perspective view showing an outline of an external body 200 provided to the solid state battery cell according to the present embodiment;

FIG. 5 is a perspective view showing an outline of an external body 300 provided to the solid state battery cell according to the present embodiment;

FIG. 6 is a perspective view showing an outline of an external body 400 provided to the solid state battery cell according to the present embodiment;

FIG. 7 is a perspective view showing an outline of an external body 500 provided to the solid state battery cell according to the present embodiment;

FIG. 8 is a schematic drawing of a film forming the external body in which a folding line was formed prior to forming the external body;

FIG. 9 is a perspective view showing an outline of an example of a manufacturing method of a battery cell which produces a battery cell 600 using a film 60A of FIG. 8; and

FIG. 10 is a perspective view showing an outline of another example of a production method of a battery cell which produces a battery cell 600 using the film 60A of FIG. 8.

### PREFERRED MODE FOR CARRYING OUT THE INVENTION

Hereinafter, a specific embodiment of the present invention will be explained in detail; however, the present invention is in no way limited to the following embodiment, and can be implemented by making appropriate changes with the scope of the object of the present invention.

### (Outline of Battery Cell)

A battery cell according to an embodiment of the present invention is a battery cell including a battery, and an external body which accommodates the battery. This battery may be a liquid battery cell using an organic electrolytic solution as the electrolyte, may be a battery cell equipped with a gel electrolyte, or may be a solid state battery cell equipped with a flame-retardant solid electrolyte as the electrolyte, in place of an electrolyte which is an organic electrolytic solution. Hereinafter, an explanation will be provided giving the example of a solid state battery cell equipped with a solid electrolyte as the battery cell.

### <Solid State Battery Cell>

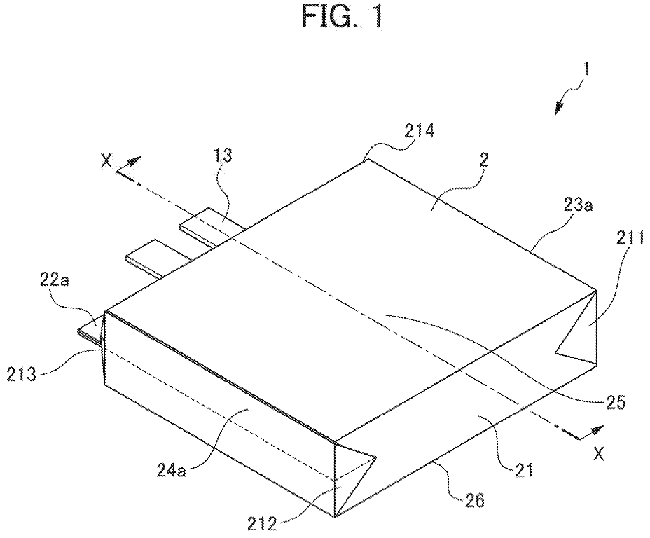

FIG. 1 is a perspective view showing an outline of a solid state battery cell 1 according to the present embodiment. The solid state battery cell 1 according to the present embodiment is a solid state battery cell including a solid state battery 10; and an external body formed by one film, and accommodating the solid state battery. The structure of an external body 2.

The solid state battery 10 includes a solid state battery laminate 11, a current collector tab 13 and a support 12. The solid state battery laminate 11 is a laminate in which at least a positive electrode layer, solid electrolyte layer and negative electrode layer are laminated in this order. It should be noted that “at least . . . laminated in this order” in the present disclosure indicates being laminated in the sequence of the listed layers, and not only these layers being directly laminated, but also indicates including indirect lamination. For example, it has a meaning permitting there being another layer, etc. between the positive electrode layer and solid electrolyte layer.

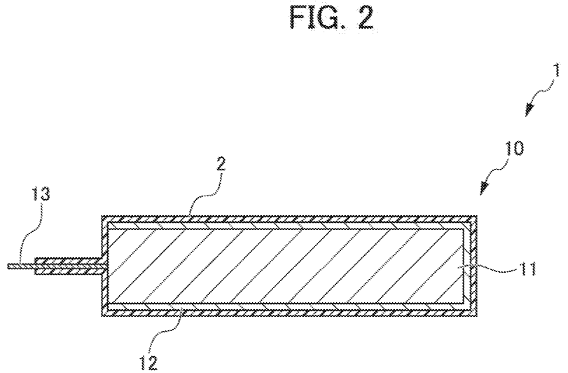

In addition, it further includes a support which accommodates the solid state battery laminate and has a cross section in the stacking direction which is substantially C-shaped (FIG. 2). The current collector tab 13 is connected to the solid state battery laminate, and an end on the opposite side to the side of the solid state battery laminate 11 is exposed from the external body 2. The support 12 has a function of protecting the solid state battery laminate 11 from external impact, by accommodating the solid state battery laminate 11.

The solid state battery cell 1 according to the present embodiment can effectively improve the energy density of the solid state battery module, while maintaining the sealing performance of the external body, due to being able to reduce the bonded area of a bonded section at which films are bonded, as described later.

Furthermore, it is possible to evacuate the inside of the external body after accommodating in the external body due to not including an electrolytic solution inside of the battery in the case of the solid state battery cell. It thereby becomes possible to fix the solid state battery laminate more firmly by the external body, and thus the durability can be improved by suppressing laminate misalignment and electrode cracking due to vibration.

Hereinafter, each constituent component related to the solid state battery cell 1 according to the present embodiment will be explained.

### (External Body)

The external body 2 is an external body which accommodates the battery cell 10. By accommodating the battery cell 10 by the external body 2, it is possible to prevent the intrusion of air to the battery cell 10.

In addition, the external body 2 is characterized by including one turnback section 21 which is formed by one film being folded back so as to accommodate the solid state battery laminate 11 of rectangular shape in a plan view. Then, the external body 2 has a top 25, bottom 26, and includes three bonded sections 22a, 23a, 24a at which ends of films opposing each other are bonded (refer to FIG. 1).

The solid state battery cell 1 according to the present embodiment suppresses the formation of dead space by reducing the bonded section in which the film is bonded, compared to a solid state battery cell made by bagging the solid state battery with two films and bonding four sides of the films opposing each other to be sealed by four bonded sections, whereby it is possible to effectively improve the energy density of a solid state battery module.

Furthermore, in the case of wrapping the battery with two films, and then sealing by bonding the four sides of film opposing each other, it is possible to form the external body so that stress is not applied as much as possible on the battery by processing these two films to form in a deep drawn shape. However, there is a limitation in the formation of such a deep drawn shape, and if the thickness of the solid state battery exceeds 20 mm, the processing these two films to form a deep drawn shape becomes difficult in itself.

If an external body formed by one film being folded back, since the film will not be formed into a deep drawn shape, it is possible to use even in a solid state battery having a thickness exceeding 20 mm. For this reason, the thickness of the battery is not particularly limited, and it is possible to use in applications for batteries which are multi-layer laminated particularly for the purpose of making high voltage or making high capacity.

Furthermore, in the external body 2, on both sides of the turnback section 21, film extension parts 211, 212 are formed by the films opposing and bonded sections being formed. Film extension part is a portion of the remainder of the film formed on both sides of the turnback section 21, when folding the film so that one film is opposing and the bonded section forms.

Then, in the solid state battery cell 1 according to the present embodiment, these film extension parts 211, 212 are folded to the side of the support. The solid state battery laminate 11 has a very weak property against external impact, and thus when pressing the film extension parts 211, 212 against the solid state battery laminate 11 and folding, this pressing is an external impact, and there is a possibility of the solid state battery laminate 11 damaging.

However, the solid state battery cell 1 according to the present embodiment further includes the support 12 accommodating the solid state battery laminate and having a cross section in the direction of stacking which is substantially C-shaped. By pressing the film extension parts 211, 212 against this support 12 and folding, it is possible to reduce the possibility of the solid state battery being damaged. In addition, since the solid state battery cell 1 according to the present embodiment includes the support 2, the fixing of the film extension parts by pressing and folding to the side of the support 2 is facilitated. So long as being a solid state battery cell in which the film extension parts 211, 212 are folded to the side of the support 2 and fixed, it is possible to effectively reduce the possibility of the film extension part becoming a protrusion upon placing a plurality of solid state battery cells side by side and storing in a case, and then the storing of the solid state battery cell being inhibited.

It should be noted that, in order to prevent the occurrence of wrinkles, etc. in the external body 2, a partial cutout may be provided in the film extension part (not shown). In addition, the external body provided to the solid state battery cell of the present invention is not limited to the external body 2 illustrated in FIG. 1, and is sufficient so long as including the turnback section and bonded section. Other forms of the external body provided to the solid state battery cell of the present invention will be described later.

(Film Forming External body)

The film forming the external body 2 is not particularly limited so long as being a film which can form the external body 2 accommodating the solid state battery laminate 11. The film forming the external body 2 is preferably a film such that can impart airtightness to the external body 2.

The film forming the external body 2 preferably includes a barrier layer consisting of an inorganic thin film such as aluminum foil, or an inorganic oxide thin film such as silicon oxide, aluminum oxide, or the like. By including a barrier layer, it is possible to impart airtightness to the external body 2.

In addition, the film forming the external body 2 preferably includes a sealing layer consisting of a flexible resin such as polyethylene resin. Sealing layers laminated on the film can be bonded by opposing each other and welding. For this reason, a step of coating an adhesive becomes unnecessary. It should be noted that the film forming the external body 2 may not necessarily include the sealing layer. It is possible to form the external body by bonding films with adhesive.

In addition, the film forming the external body 2 can be exemplified as a laminate in which a base layer consisting of polyethylene terephthalate, polyethylene naphthalate, nylon, polypropylene or the like; the above-mentioned barrier layer; and the above-mentioned sealing layer are laminated. These layers may be laminated via a conventional, known adhesive, or may be laminated by an extrusion coating method, or the like.

The preferred thickness of the film forming the external body 2 will differ depending on the material used in the film; however, it is preferably at least 50 μm, and is more preferably at least 100 μm. The preferred thickness of the film forming the external body 2 is preferably no more than 700 μm, and is more preferably no more than 200 μm.

A single film forming the external body may be a film of one layer, or a laminate having a plurality of layers. It should be noted that the shape of the one film of the present invention may be a flat film of polygonal shape (rectangular shape), or may be a tubular film, as described later.

### (Solid State Battery)

FIG. 2 shows a cross-sectional view cutting along the line X-X in FIG. 1 of the solid state battery cell 1 (solid state battery 10) according to the present embodiment. The battery cell 10 is accommodated in the external body 2, and the battery cell 10 includes the solid state battery laminate 11, current collector tab 13 and support 12. Each member constituting the solid state battery 10 will be explained.

### (Solid State Battery Laminate)

The solid state battery laminate 11 is a laminate in which the positive electrode layer, solid electrolyte layer and negative electrolyte layer are at least laminated, and more specifically, is a laminate including the positive electrode current collector layer, positive electrode layer, solid electrolyte layer, negative electrode layer, and negative electrode current collector layer. Furthermore, by laminating a plurality of these configurations as a unit battery, a high-output battery may be formed.

### (Positive Electrode Layer)

The positive electrode layer is a layer containing at least a positive electrode active material. As the positive electrode active material, it is sufficient so long as appropriately selecting and using a material which can release and occlude a conventional, known ion (for example, lithium ion). As specific examples of the positive electrode active material, it is possible to exemplify lithium cobalt oxide (LiCoO₂), lithium nickel oxide (LiNiO₂), LiNiₚMn_{q}CoᵣO₂ (p+q+r=1), LiNiₚAl_{q}COᵣO₂ (p+q+r=1), lithium-manganese (LiM₂O₄), a different kind element substituted Li—Mi spinel expressed by Li₁+xMn₂−x−yMyO₄ (x+y=2, M=at least one selected from Al, Mg, Co, Fe, Ni and Zn), lithium phosphate metal (LiMPO₄, M=at least one selected from Fe, Me, Co and Ni), etc.

### (Negative Electrode Layer)

The negative electrode layer is a layer containing at least a negative electrode active material. As the negative electrode active material, it is not particularly limited so long as being able to occlude and release ions (for example, lithium ions), and it is possible to exemplify lithium transition metal oxides such as lithium titanium oxide (Li₄Ti₅O₁₂), transition metal oxides of TiO₂, Nb₂O₃, WO₃, etc., metal sulfides, metal nitrides, and carbon materials such as graphite, soft carbon and hard carbon, as well as lithium metal, indium metal, and lithium alloys. In addition, the negative electrode active material may be powder form, or may be thin film form.

### (Solid Electrolyte Layer)

The solid electrolyte layer is a layer laminated between the positive electrode layer and the negative electrode layer, and is a layer at least containing the solid electrolyte material. It is a layer which can carry out ion conduction (e.g., lithium ion conduction) between the positive electrode active material and negative electrode active material through the solid electrolyte material contained in the solid electrolyte layer.

As the solid electrolyte material, it is not particularly limited so long as having ion conductivity (for example, lithium ion conductivity); however, for example, it is possible to exemplify a sulfide solid electrolyte material, oxide solid electrolyte material, nitride solid electrolyte material, halogenide solid electrolyte material, etc. and thereamong, a sulfide solid electrolyte material is preferable. This is because, compared to an oxide solid electrolyte material, the ion conductivity is high.

### (Positive Electrode Current Collector Layer)

The positive electrode current collector layer is not particularly limited so long as having a function of performing current collection of the positive electrode layer, for example, it is possible to exemplify aluminum, aluminum alloy, stainless steel, nickel, iron, titanium, etc., and thereamong, aluminum, aluminum alloy and stainless steel are preferable. In addition, as the form of the positive electrode current collector, for example, foil form, plate form, mesh form, etc. can be exemplified, and thereamong, foil form is preferable.

### (Negative Electrode Current Collector Layer)

The negative electrode current collector layer is not particularly limited so long as having a function of performing current collection of the negative electrode layer. As the material of the negative electrode current collector, for example, it is possible to exemplify nickel, copper, stainless steel, etc. In addition, as the form of the negative electrode current collector, for example, it is possible to exemplify foil form, plate form, mesh form, etc., and thereamong, mesh form is preferable.

### (Current Collector Tab)

The current collector tab 13 is connected to the solid state battery laminate 11, and the end on the opposite side to the side of the solid state battery laminate 11 is a tab which is exposed from the external body 2. By providing the current collector tab 13, it should be noted that the current collector tab 13 is sufficient so long as being exposed from the bonded sections 22 to 24. In this way, the bonded sections 22 to 24 maintain the airtightness of the external body, and expose the current collector tab 13 to have a function as an electrical outlet.

As materials which can be used in the current collector tab 13, it is possible to use materials of the same type as the current collector tab used in a conventional solid state battery, and are not particularly limited.

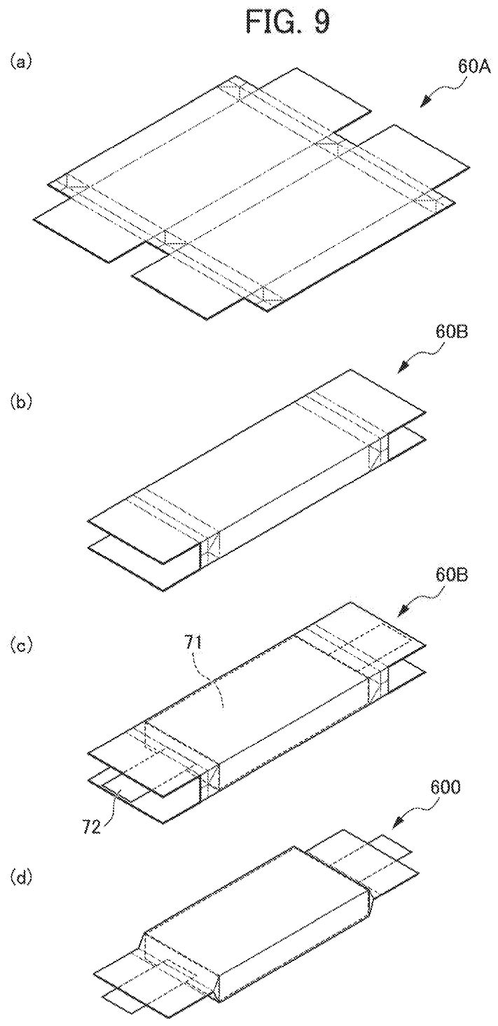

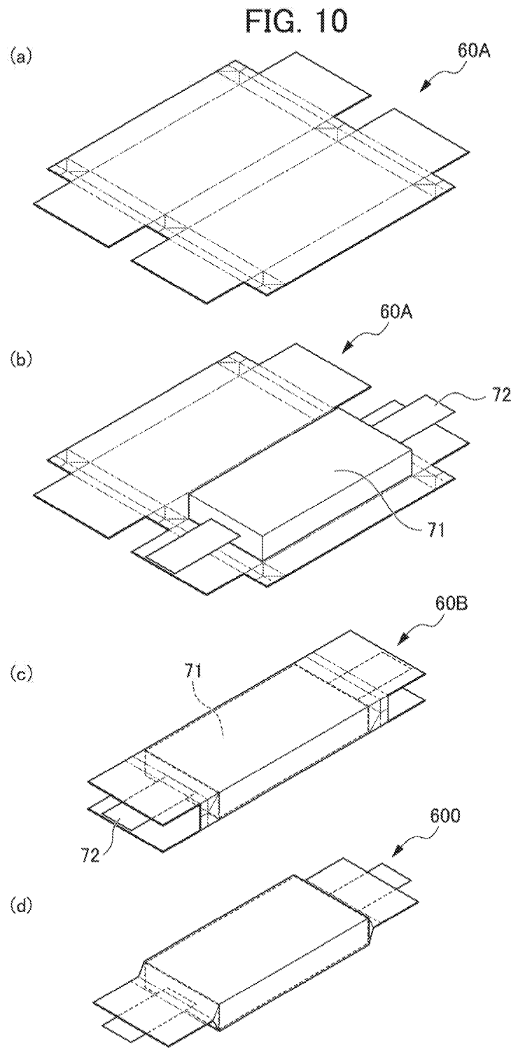

In addition, the current collector tab is not limited to being connected to one side of the solid state battery laminate such as that shown in FIG. 1. For example, one current collector tab may be connected to each of two sides of the solid state battery laminate (for example, FIG. 9(d) and FIG. 10(d)).

### (Support)

The support 12 is a member which accommodates the solid state battery laminate 11. The support 12 has a function of protecting the solid state battery laminate 11 from external impact, by accommodating the solid state battery laminate.

The shape is not limited so long as the support covers at least part of the solid state battery laminate so as to accommodate the solid state battery laminate. For example, the support may be a shape having a cross section in the direction of stacking that is substantially C-shaped as shown in FIG. 2. Then, it may be made a configuration such that the current collector tab is connected from the end of the solid state battery laminate which is not covered by the support.

The material of the support 12 is not particularly limited; however, it is preferably a material having rigidity, and it is possible to exemplify resins consisting of polyethylene terephthalate, polyethylene naphthalate, nylon, polypropylene, etc.; rubber such as natural rubber and silicon rubber; metals such as stainless steel and aluminum (including alloys); ceramics, etc. It should be noted that, if the support is rubber, there will be an effect of cushioning external impact, and since the coefficient of friction is high, retention of the electrode will also be high.

The thickness of the support 12 is not particularly limited; however, being 0.01 mm or more is preferable, and being 0.1 mm or more is more preferable. By the thickness of the support 12 being at least 0.01 mm, it is possible to reduce the possibility of the solid state battery being damaged from external impact including the pressing against the film extension parts. It should be noted that the thickness of the support 12 is preferably no more than 1 mm from the viewpoint of productivity, etc.

### <Production Method of Solid State Battery Cell>

The production method of the solid state battery cell, for example, can be exemplified by a method including (1) a step of producing the solid state battery 10 and a film forming external body 2; (2) a step of folding back the film so as to accommodate the solid state battery laminate 11, and forming the turnback section 21 and bonded sections 22 to 24 by bonding ends of the film opposing each other; and (3) a step of folding the film extension parts 211, 212 formed at both sides of the turnback section 21 in the solid state battery laminate 11 to the side of the support 12.

The solid state battery laminate 11 of the solid state battery 10 is produced by laminating the above-mentioned positive electrode, solid electrolyte layer and negative electrode in this order. It should be noted that, after laminating the positive electrode, solid electrolyte layer and negative electrode, it may be optionally integrated by pressing.

In addition, the solid state battery laminate 11 may be accommodated by the support 12 so that the cross section in the direction of stacking of the solid state battery laminate becomes substantially C-shaped. It may be made a configuration such that includes the current collector tab connected to the solid state battery laminate.

The method of opposing and bonding the film at each bonded section may be a dry laminate method using adhesive, or may be formed by welding with heat, ultrasound or the like.

After folding the film extension parts 211, 212 to the side of the support, it is preferable to fix the film extension parts 211, 212 by tape or adhesive.

It should be noted that the solid state battery cell according to the present embodiment is not limited to this production method. For example, it may be a method which produces in advance the external body in a state in which two sides are welded using the film obtained in the step of producing the film, and bags the solid state battery laminate in this external body. By welding two sides in advance, there is an advantage in that it is possible to curb the production cost.

<Regarding Battery Cells other than Solid state Battery Cell>

The battery cell of the present invention is not limited to a solid state battery cell equipped with the above-mentioned solid electrolyte, and may be a liquid battery cell using an electrolytic solution as the electrolyte, or may be a battery cell including a gel electrolyte.

The liquid battery cell, for example, includes a battery laminate in which at least a positive electrode layer, separator, and negative electrode layer are laminated in this order, and an electrolytic solution. The electrolytic solution, for example, is accommodated within the external body. So long as being a liquid battery cell using an electrolytic solution as the electrolyte, it is possible for the interface resistance between the electrode and electrolyte to decrease compared to a solid state battery equipped with a solid electrolyte. In addition, it is possible to produce the liquid battery at low cost due to mass production already being established.

In the case of the liquid battery cell, as the electrolytic solution, it is possible to exemplify one made by dissolving a supporting electrolyte such as LiPF₆, LiBF₄, and LiClO₄ in a solvent such as ethylene carbonate, propylene carbonate, dimethyl carbonate and diethyl carbonate.

In addition, in the case of a battery cell equipped with a gel electrolyte, it is preferable to use an electrolyte gelled by combining the electrolytic solution with a polymer such as polyvinylidene fluoride-hexafluoropropylene (PVDF-HFP), (poly)acrylate, and polymethyl methacrylate.

It should be noted that, other than the electrolyte, the positive electrode layer and negative electrode layer can employ those similar to the aforementioned solid state battery cell.

### <Other Embodiments of External Body>

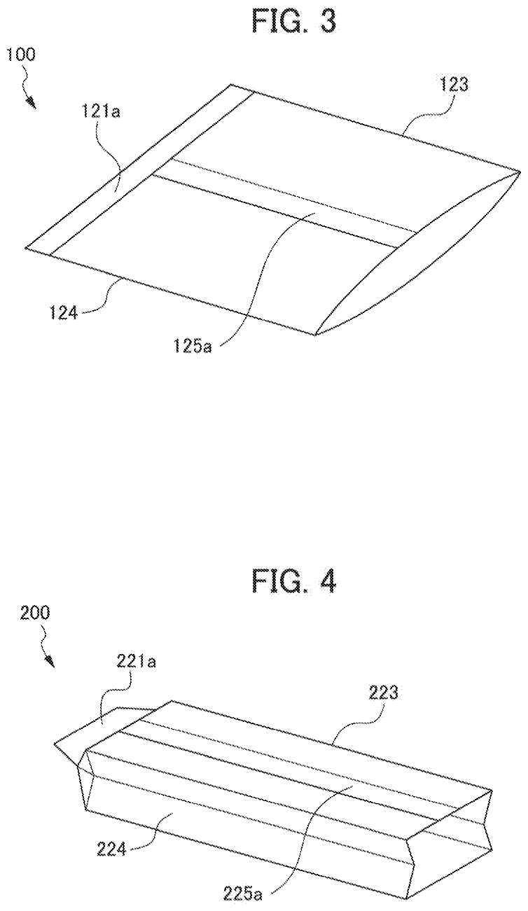

Other embodiments of the external body equipped to the solid state battery cell of the present invention will be explained. It should be noted that the portions shared with the solid state battery 1 according to the above-mentioned embodiment will be omitted as appropriate. The external body 100 illustrated in FIG. 3 includes two turnback sections 123, 124 formed by one film being folded back. Then, the external body 100 includes the bonded section 121a at which the ends of the film opposing each other are bonded (refer to FIG. 3).

Then, the external body 100 illustrated in FIG. 3 is characterized by including a bonded section 125a at which ends of the film opposing each other on the top face are bonded. So long as being the external body 100 illustrated in FIG. 3, since the bonded section is arranged on the top face of the solid state battery cell, it is possible to reduce the dead space formed by the bonded section. Consequently, so long as being the solid state battery cell equipped with the external body 100 illustrated in FIG. 3, it is possible to effectively improve the energy density of the solid state battery module.

The external body 200 illustrated in FIG. 4 includes the two turnback sections similarly to the external body 100 illustrated in FIG. 3; however, it is characterized by a gusset being formed at the two turnback sections 223, 224, and thus is an external body of so-called lateral gusset form.

The external body 200 illustrated in FIG. 4 is characterized by being able to accommodate a thicker solid state battery cell. In other words, it is especially useful in a solid state battery cell made by laminating several layers with the purpose of making a solid state battery cell higher voltage or higher capacity.

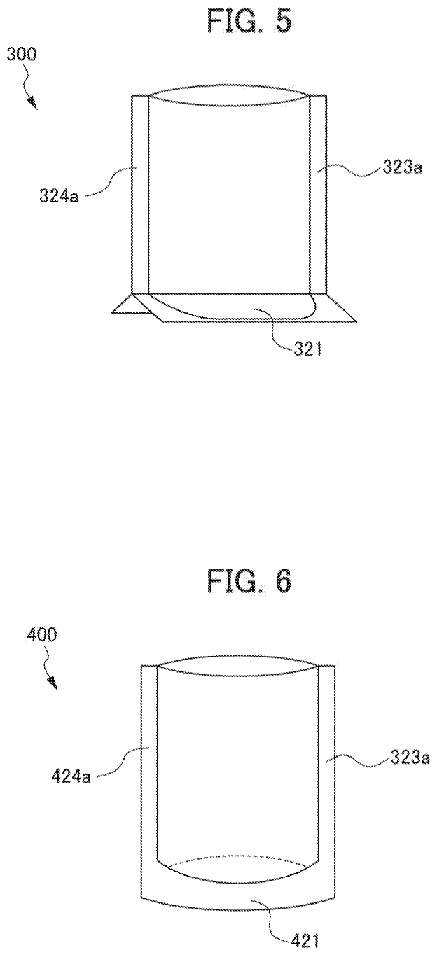

The external body 300 illustrated in FIG. 5 includes one turnback section similarly to the external body 2 illustrated in FIG. 1, but is characterized by a gusset being formed in the turnback section 321, i.e. is an external body of so-called bottom gusset form.

The external body 400 illustrated in FIG. 6 includes one turnback section similarly to the external body 300 illustrated in FIG. 5; however, it is characterized by a substantially circular bottom part being formed in place of the gusset at the turnback section 421, i.e. is an external body of standing bag shape.

The external body 300, 400 illustrated in FIGS. 5 and 6, due to being able to vertically arrange the external body by establishing the turnback sections 321, 421 as the bottom part, is useful from the viewpoint of productivity facilitating bagging of the solid state battery cell.

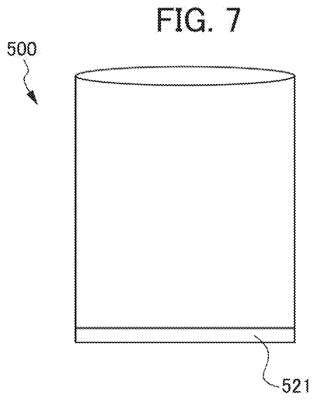

The external body 500 illustrated in FIG. 7 is an external body produced from one cylindrical film, and is characterized by being able to accommodate the solid state battery laminate within the one cylindrical film.

The external body 500 illustrated in FIG. 7 can reduce the bonded sections by forming the one film into a cylindrical shape in advance. It is thereby possible to effectively further improve the sealing performance of the external body.

It should be noted that the production method of one cylindrical film is not particularly limited; however, for example, it can be produced by centrifugal molding or press molding resin.

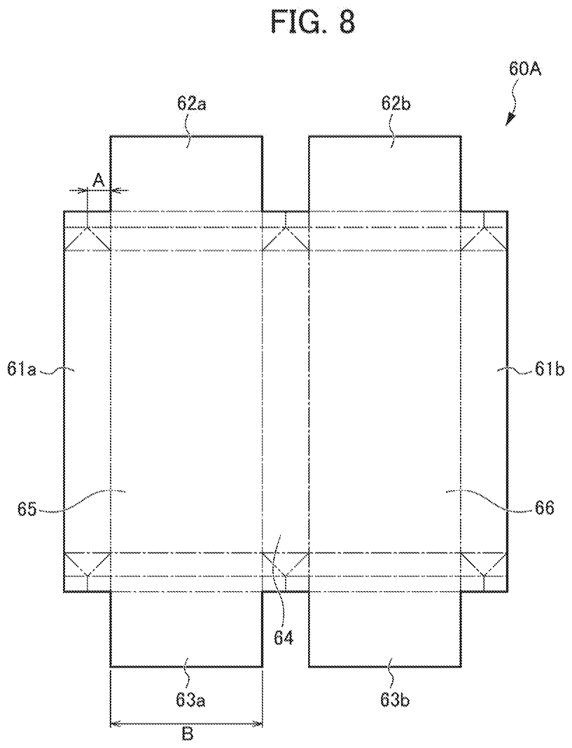

FIG. 8 is a film forming the external body, in which a folding line prior to forming the external body is formed. The folding line of this film 60A is prepared according to the shape and size of the battery to be accommodated in the external body. By forming the folding line in advance as in the film 60A of FIG. 8, the work of the steps of folding the film thereafter, and the step of inserting the battery and sealing the films becomes easier to do, and thus work efficiency improves.

The film 60A includes sealing parts 61a, 61b, 62a, 62b, 63a, 63b, and the sealing part 61a and sealing part 61b are sealed, the sealing part 62a and sealing part 62b are sealed, and the sealing part 63aa and sealing part 63b are each sealed. It should be noted that the relationship between the length A and length B in FIG. 8 preferably has the relationship of A>B/2.

FIG. 9 represents the flow of producing the battery cell 600 using the film 60A of FIG. 8. First, the film 60A is prepared by forming the folding line, etc. in advance as showing the single film in FIG. 9(a). This folding line is prepared according to the shape and size of the battery to be accommodated in the external body. Next, so as to seal the sealing part 61a and sealing part 61b, the film 60B folded back into a cylindrical shape is prepared (FIG. 9(b)). Next, the battery including the battery laminate 71 and current collector tab 72 is inserted inside of the film 60B folded back into a cylindrical shape (FIG. 9(c)). Finally, the battery cell 600 is prepared by sealing the sealing part 61a and sealing part 61b, and sealing the sealing part 62a and sealing part 62b. So long as being a production method of such a battery cell, due to no longer needing to press against the battery laminate 11 and fold the film, the battery laminate 11 will not be damaged by pressing against the battery laminate 11. For this reason, in a case of producing by the production method of the battery cell shown in FIG. 9, it may not necessarily include the support accommodating this battery laminate.

Furthermore, so long as being the production method of the battery cell shown in FIG. 9, it can be suitably used even if being a solid state battery cell including a solid electrolyte, if being a liquid battery cell using an organic electrolytic solution as the electrolyte, or being a battery cell including a gel electrolyte.

FIG. 10 represents the flow of producing the battery cell 600 by a method different from FIG. 9, using the film 60A of FIG. 8. The point differing from FIG. 9 is in the point of placing the battery laminate 71 (battery) onto a film in which a folding line was formed (FIG. 10(b)), and folding back into a cylindrical shape so as to seal the sealing part 61a and sealing part 61b (FIG. 10(c)), instead of inserting the battery including the battery laminate 71 and current collector tab 72 inside of the film 60B folded back into a cylindrical shape.

By placing the battery laminate 71 onto the film in which the folding line was formed, and sealing the sealing parts, it is made possible to accommodate the battery in a state with less of a gap compared to the production method of the battery cell shown in FIG. 9. It is thereby possible to effectively improve the energy density of the battery module.

The battery cell 600 produced by the production method of the battery cells shown in FIGS. 9 and 10 includes the turnback section formed by one film being folded back so that the external body accommodates the battery, and the bonded section; therefore, it is possible to effectively improve the energy density of the battery module, while maintaining the sealing performance of the external body. Furthermore, it is possible to further improve the energy density of the battery module, by arranging the bonding surface and the direction in which stacking the battery cells to be perpendicular.

In the case of being a solid state battery cell including a solid electrolyte, it is preferable to evacuate the inside of the external body upon sealing a sealing part and another sealing part. The atmospheric pressure comes to be applied uniformly to the end face of the battery cell at which the turnback section is formed, whereby it becomes possible to fix the solid state battery laminate more firmly by the external body. In addition, it is possible to improve the durability by suppressing the lamination deviation and electrode cracking of the solid state battery laminate by vibration.

According to the above, the battery cell of the present invention can effectively improve the energy density of a battery module, while maintaining the sealing performance of the external body.

### EXPLANATION OF REFERENCE NUMERALS

1 battery cell (solid state battery cell)

10 battery (solid state battery)

11 battery laminate (solid state battery laminate)

12 support

13 current collector tab

2 external body

21 turnback section

22a bonded section

23a bonded section

24a bonded section

25 top face

26 bottom face

211 film extension part

212 film extension part

100 external body

121a bonded section

123 turnback section

124 turnback section

125 bonded section

200 external body

221 bonded section

223 turnback section (gusset)

224 turnback section (gusset)

225a bonded section

300 external body

321 turnback section (gusset)

323a bonded section

324a bonded section

400 external body

421 turnback section (bottom part)

423a bonded section

424a bonded section

500 external body

521a bonded section

60A film

61a, 61b, 62a, 62b, 63a, 63b sealing part

64 turnback section

65 top face

66 bottom face

71 battery laminate

72 current collector tab

60B film folded back into cylindrical shape

600 battery cell

1. A battery cell comprising a battery and an external body which accommodates the battery,
wherein the battery includes a positive electrode, an electrolyte and a negative electrode, and
wherein the external body includes a turnback section which is formed by one film being folded back so as to accommodate the battery, and a bonded section in which ends of the film opposing each other are bonded.

2. The battery cell according to claim 1,
wherein the battery includes a battery laminate in which at least a positive electrode layer, electrolyte layer and negative electrode layer are laminated in this order, and
wherein the external body includes: a turnback section formed by one film being folded back so as to accommodate the battery laminate, and a bonded section in which ends of the film opposing each other are bonded.

3. The battery cell according to claim 1, wherein the battery further includes a support which accommodates the battery laminate, and
wherein a film extension pan of the external body formed on both sides of the turnback section by the bonded section being formed is folded to a side of the support.

4. The battery cell according to claim 1, wherein the external body accommodates the battery laminate within one film of cylindrical shape.

5. The battery cell according to claim 1, wherein the battery further includes a current collector tab connected to the battery laminate, and
wherein an end of the current collector tab on an opposite side to a side of the battery laminate is exposed from the external body.

6. The battery cell according to any one of claim 1, wherein the bonded section is formed by welding.

7. The battery cell according to claim 2, wherein the battery further includes a support which accommodates the battery laminate, and
wherein a film extension part of the external body formed on both sides of the turnback section by the bonded section being formed is folded to a side of the support.

8. The battery cell according to claim 2, wherein the external body accommodates the battery laminate within one film of cylindrical shape.

9. The battery cell according to claim 2, wherein the battery further includes a current collector tab connected to the battery laminate, and
wherein an end of the current collector tab on an opposite side to a side of the battery laminate is exposed from the external body.

10. The battery cell according to any one of claim 2, wherein the bonded section is formed by welding.

11. The battery cell according to claim 3, wherein the external body accommodates the battery laminate within one film of cylindrical shape.

12. The battery cell according to claim 3, wherein the battery further includes a current collector tab connected to the battery laminate, and
wherein an end of the current collector tab on an opposite side to a side of the battery laminate is exposed from the external body.

13. The battery cell according to any one of claim 3, wherein the bonded section is formed by welding.

14. The battery cell according to claim 4, wherein the battery further includes a current collector tab connected to the battery laminate, and
wherein an end of the current collector tab on an opposite side to a side of the battery laminate is exposed from the external body.

15. The battery cell according to any one of claim 4 wherein the bonded section is formed by welding.

16. The battery cell according to any one of claim 5, wherein the bonded section is formed by welding.
